(19) United States
(12) Patent Application Publication
(10) Pub. No.: US 2024/0038997 A1
(43) Pub. Date: Feb. 1, 2024

(54) Anode Current Collector Modification for Lithium Metal Batteries

(71) Applicants: Nissan North America, Inc., Franklin, TN (US); Nissan Motor Co., Ltd., Yokohama-shi (JP)

(72) Inventors: Shigemasa Kuwata, Palo Alto, CA (US); Hideyuki Komatsu, San Diego, CA (US); Balachandran Gadaguntla Radhakrishnan, Mountain View, CA (US); Maarten Sierhuis, San Francisco, CA (US); Takuya Mishina, Kanagawa (JP); Kazuyuki Sakamoto, Kanagawa (JP)

(21) Appl. No.: 17/877,314

(22) Filed: Jul. 29, 2022

(51) Int. Cl. H01M 4/66; H01M 10/052; H01M 4/38

(52) U.S. Cl. CPC H01M 4/661; H01M 10/052; H01M 4/667; H01M 4/382

(57) ABSTRACT

A lithium metal battery cell has an electrolyte and an anode comprising an anode current collector and a thin film metal layer formed on the anode current collector, the thin film metal layer consisting of a metal that forms a solid solution with lithium metal. The thin film metal layer is configured to promote dense lithium deposition between the thin film metal layer and the electrolyte during charging.

### TECHNICAL FIELD

This disclosure relates to the modification of the anode current collector of a lithium metal battery with a metal thin film provided directly on the anode current collector.

### BACKGROUND

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to negative reactions with active materials, or ionic liquid electrolytes, with increased viscosities and lower ionic conductivity. All-solid-state batteries (ASSB) can address some or all of these issues, as well as produce higher energy densities. However, the large interfacial resistance at the electrolyte/electrode interface and the interfacial stability and compatibility due to lithium reactivity affect the electrochemical performance of both ASSB s and lithium metal batteries. Un-uniform lithium plating and formation of lithium dendrites contribute to the decrease in performance.

### SUMMARY

Disclosed herein are implementations of a lithium metal battery cell having a modified anode current collector having a flexible thin film of metal applied to an electrolyte-facing side of the anode current collector. The anode current collector modification promotes dense, uniform lithium metal plating between the modified anode current collector and the electrolyte, suppressing dendrite formation, improves coulombic efficiency, and allows for quick charging.

As disclosed herein, a lithium metal battery cell can comprise an electrolyte and an anode comprising an anode current collector and a thin film metal layer formed on the anode current collector, the thin film metal layer consisting of a metal that forms a solid solution with lithium metal. The thin film metal layer is configured to promote dense lithium deposition between the thin film metal layer and the electrolyte during charging.

As also disclosed, a lithium metal battery cell can comprise a cathode comprising a lithium-containing cathode active material, an electrolyte, and an anode. The anode has an anode current collector and a thin film metal layer formed on the anode current collector and consisting of a metal that satisfies formula:

η_{Li_depo}=−432.76*E_{formation} (eV)−0.3037

wherein η_{Li_depo} is lithium deposition overpotential and E_{formation} is formation energy at 1%/eV of Li99A, wherein A is the metal, and η_{Li_depo} is between 0 mV and 8 mV, inclusive.

Variations in these and other aspects, features, elements, implementations, and embodiments of the methods and apparatus disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-sectional schematic of a lithium metal battery cell as assembled and prior to charging, as disclosed herein.

FIG. 2 is a cross-sectional schematic of a lithium metal battery cell after an initial charging, as disclosed herein.

FIG. 3 is a graph of formation energy of Li99A, A being a metal, against measured overpotential of lithium metal.

FIG. 4 is a graph of formation energy of Li99A against predicted overpotential using the developed formula as disclosed herein, showing the lithium deposition overpotential of stainless steel as an example.

FIG. 5 is a graph of formation energy versus measured overpotential for a variety of metals.

### DETAILED DESCRIPTION

Lithium metal batteries offer higher volumetric and gravimetric energy densities than conventional lithium-ion batteries. The lithium metal anode has a theoretical gravimetric capacity approximately ten times higher than graphite-based anodes. However, non-uniform electrodeposition of lithium, which results in dendrites, is holding back the widespread adoption of lithium metal batteries. During battery operation, lithium is continuously deposited or removed depending on charge/discharge cycles. As the lithium is deposited, it may not deposit uniformly, forming dendrites, which are tiny, rigid branch-like structures and needle-like projections. The formation of dendrites results in a non-uniform lithium surface which further exasperates non-uniform lithium deposition. As the dendrites grow from this non-uniform deposition, battery deterioration can occur. As the lithium dendrites reach the other electrode, short circuiting of the battery can occur.

Disclosed herein is a lithium metal battery cell having a modified anode current collector, the modification being a thin film layer of metal on an electrolyte-facing side of the anode current collector. The thin film layer is formed directly onto the anode current collector. The thin film layer of metal promotes the homogeneous and dense distribution and deposition of lithium metal between the modified anode current collector and the electrolyte during charging. The dense lithium plating suppresses short circuiting and cell expansion during charging, improving volumetric energy density. Use of the modified current collector results in improved coulombic efficiency and allows for quick charge processes to be used in charging the battery.

A lithium metal battery cell 100 as disclosed is illustrated schematically in cross-section in FIG. 1. The lithium metal battery cell 100 of FIG. 1 may be configured as a layered ASSB cell that includes as active layers a cathode 102 having active cathode material layer, an electrolyte 104 that is solid, and an anode current collector 106. A thin film metal layer 108 as disclosed herein, that modifies the surface of the anode current collector 106, is formed on the anode current collector 106 between the anode current collector 106 and the electrolyte 104. In addition, the lithium metal battery cell 100 of FIG. 1 may include a cathode current collector 110, configured such that the active layers are interposed between the anode current collector 106 and the cathode current collector 110. Alternatively, the lithium metal battery cell 100 may use a liquid or gel electrolyte as electrolyte 104 and may further include a separator in the liquid or gel electrolyte between the thin film metal layer 108 and the cathode 102. A lithium metal battery is formed of multiple lithium metal battery cells 100.

The anode current collector 106 can be, as a non-limiting example, a sheet or foil of stainless steel, copper, nickel, a copper-nickel alloy, carbon paper, or graphene paper.

In lithium metal batteries, the electrolyte 104 may include a liquid electrolyte, a polymer ionic liquid, a gel electrolyte, or a combination thereof. The electrolyte can be an ionic liquid-based electrolyte mixed with a lithium salt. The ionic liquid may be, for example, at least one selected from N-Propyl-N-methylpyrrolidinium bis(fluorosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FSO) group, e.g., lithium bisfluorosulfonylimide (LiN(FSO₂)₂, (LiFSI), LiN(FSO₂)₂, LiN(FSO₂)(CF₃SO₂), LiN(FSO₂)(C₂F₅SO₂). In some embodiments, the electrolyte is or includes a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. Where a separator is used, such as with a liquid or gel electrolyte, the separator can be a polyolefine or a polyethylene, as non-limiting examples.

In ASSBs, the electrolyte 104 is solid. The solid electrolyte can be, as non-limiting examples, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The cathode current collector 110 can be, as a non-limiting example, an aluminum sheet or foil, carbon paper or graphene paper.

The cathode active material layer of the cathode 102 has cathode active material that can include one or more lithium transition metal oxides and lithium transition metal phosphates which can be bonded together using binders and optionally conductive fillers such as carbon black. Lithium transition metal oxides and lithium transition metal phosphates can include, but are not limited to, LiCoO₂, LiNiO₂, Li(Ni_{0.5}Mn_{0.5})O₂, LiMnO₂, Spinel Li₂Mn₂O₄, LiFePO₄, LiNiₓCo_{y}Mn_{z}O₂, LiNi_{0.8}Co_{0.15}Al_{0.05}O₂, and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. The cathode active material layer 102 can be a sulfur-based active material and can include LiSO₂, LiSO₂Cl₂, LiSOCl₂, and LiFeS₂, as non-limiting examples.

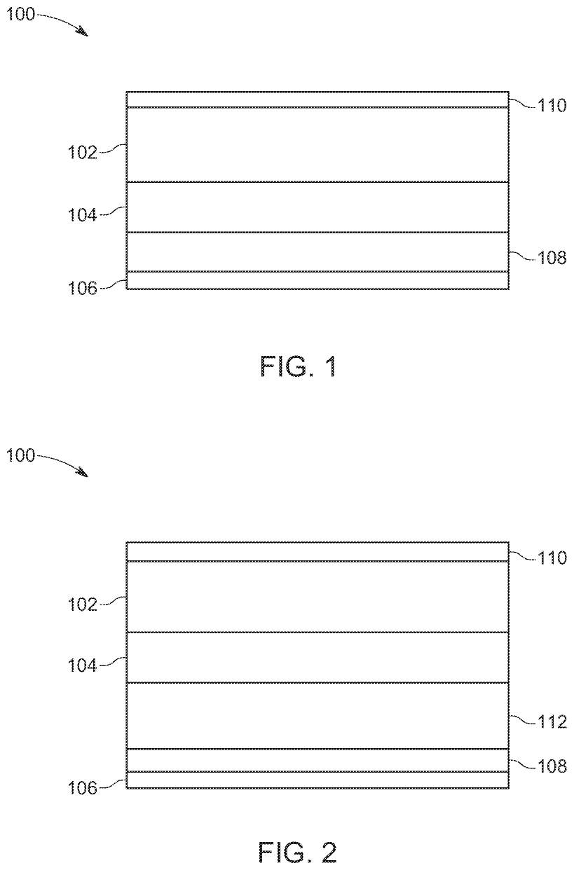

FIG. 1 illustrates the assembled lithium metal battery cell 100 disclosed herein in a manufactured state, prior to charging. Modifying the anode current collector 106 with the thin film metal layer 108 using a deposition method such as sputtering, plating, electronic beam vapor deposition or chemical vapor deposition allows for a thin, uniform, dense layer. FIG. 2 illustrates the lithium metal battery cell 100 after at least one charge, wherein lithium metal from the lithium-containing cathode material of the cathode 102 is deposited during charging on the thin film metal layer of the modified anode current collector, between the thin film metal layer 108 and the electrolyte 104, forming the lithium metal anode 112.

The thin film metal layer 108 of the modified anode current collector consists of one or more metals that form a solid solution with lithium metal. The thin film metal layer 108 adheres to the anode current collector 106 and is found to remain intact and in contact with the anode current collector throughout the life of the lithium metal battery. This is in contrast to interlayers that use, for example, inorganic materials as an interlayer that tend to peel and crack due to stress during the life of the battery. The improved life of the thin film metal layer 108 may be due to the location in which the lithium metal deposits. For lithium metal battery cells incorporating a layer of inorganic material, for example, the lithium metal deposits between the anode current collector and the layer of inorganic material. The thin film metal layer 108 as disclosed herein remains adhered to the anode current collector, promoting the dense, uniform plating of lithium metal on top of the thin film metal layer 108. The dense, uniform plating of lithium metal occurs even though the lithium metal is exposed to the electrolyte 104, whether liquid or solid. Because the lithium metal deposits on the thin film metal layer 108, it is contemplated that the metal used in the thin film metal layer 108 may be used to form the anode current collector itself, eliminating the need for producing the thin film on a traditional anode current collector.

Starting with a discharged state of the lithium metal battery cell, the modified anode current collector with the thin film metal layer 108 promotes the formation of a dense, uniform lithium metal anode through charging with the lithium metal being deposited with very low or no overpotentials. This has been demonstrated with both liquid electrolytes and solid electrolytes. The metal(s) in the thin film metal layer 108 are those metals that can form a solid solution in lithium. Such metals tend to have very low overpotentials while those metals that either form alloys with little solid solubility or those metals that do not form any intermetallic compounds, such as Cu and Ni, have very high overpotentials. The inventors have discovered that a thin film consisting of one or more metals having an overpotential with lithium of less than or equal to 8 mV but greater than or equal to 1 mV, and more particularly, less than or equal to 5 mV and greater than or equal to 0 mV, results in dense, uniform deposition of the lithium metal during charging without the formation of dendrites.

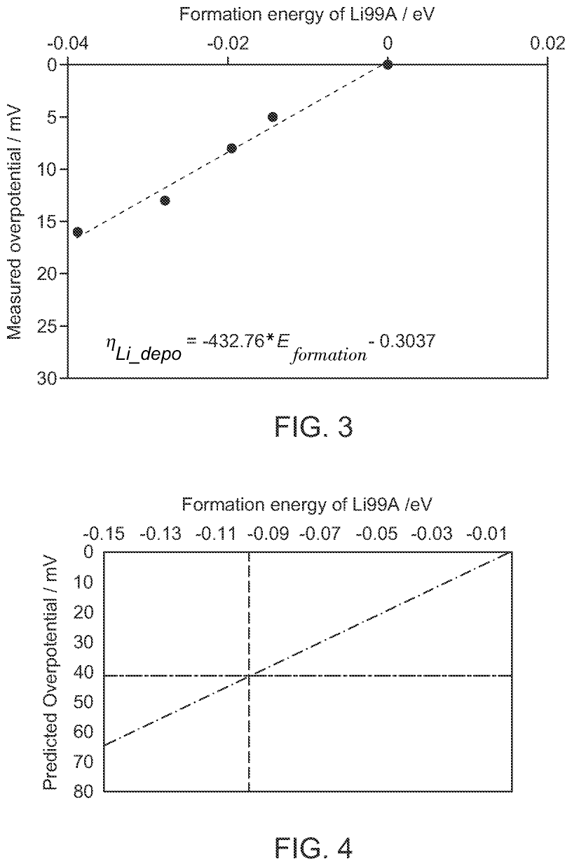

The inventors have discovered that there is a linear correlation between the formation energy and the overpotential of lithium deposition. Overpotential (η_{Li_depo}) can be predicted by calculating the formation energy of Li99A, with A being a metal, using the following relationship, graphed in FIG. 3:

η_{Li_depo}=−432.76*E_{formation} (eV)−0.3037

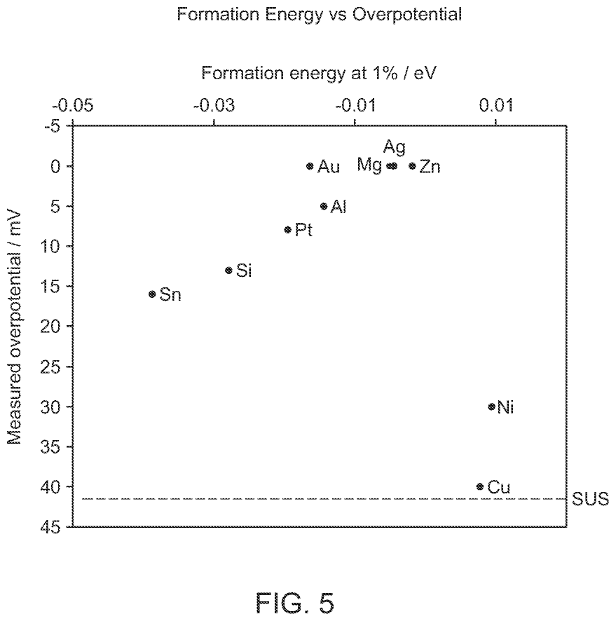

Stainless steel, the material often used as the anode current collector, has a formation energy of Li99A of −0.096 eV and so has a predicted overpotential of 41 mV using the formula above. See FIG. 4. The conventional lithium metal battery cells have significant problems with dendrite formation. The goal is to modify the anode current collector or the anode to significantly improve the uniformity and density of the lithium deposits. Performance will improve using materials having a lower predicted overpotential and a higher formation energy with lithium. FIG. 5 shows the overpotential for a variety of metals and carbon/metal composites. The overpotentials are low or close to zero if the solid solution formation energies are within +/−∈→0. As the formation energy increases to the right, the overpotential dramatically increases as is seen in the case of Ni and Cu. Both these metals do not form any solid solution or intermetallic compounds with lithium at room temperature. In the case of metals such as Pt, Si and Sn, the formation enthalpy, while favorable, decreases, which also leads to an increase in overpotentials. The higher formation energy leads to stronger bonding between the metal atoms and lithium. On the other hand, the repulsive energy between, for example, Cu and lithium or Ni and lithium leads to larger overpotentials. A near zero formation energy ensures ease of mobility of the lithium ions, reflecting in near zero overpotentials.

The thin film metal layers disclosed herein consist of one or more metals having an overpotential with lithium of less than or equal to 8 mV, and more particularly, less than or equal to 5 mV, or 0 mV to ≤5 mV, results in dense, uniform deposition of the lithium metal during charging without the formation of dendrites. Based on the formula developed by the inventors to predict the overpotential of a metal, the thin film metal layers disclosed herein consist of one or more metals having a formation energy at 1% with lithium metal of −0.02 eV or less to 0 eV, and more particularly, less than or equal to 0.0123 eV to 0 eV.

As seen in FIG. 5, exemplary metals used to product the thin film metal layer 108 disclosed herein include Pt, Al, Au, Mg, Ag and Zn, and more particularly, Al, Au, Mg, Ag and Zn.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium metal battery cell, comprising:
an electrolyte; and
an anode comprising:
an anode current collector; and
a thin film metal layer formed on the anode current collector, the thin film metal layer consisting of a metal that forms a solid solution with lithium metal, the thin film metal layer configured to promote dense lithium deposition between the thin film metal layer and the electrolyte during charging.

2. The lithium metal battery of claim 1, wherein the metal is one or more metals selected from Au, Al, Mg, Ag, Zn, and Pt.

3. The lithium metal battery of claim 1, wherein the metal is one or more metals selected from Au, Al, Mg, Ag, and Zn.

4. The lithium metal battery of claim 1, wherein the metal satisfies formula I:
η_{Li_depo}=−432.76*E_{formation} (eV)−0.3037
wherein η_{Li_depo} is lithium deposition overpotential and E_{formation} is formation energy at 1%/eV of Li99A, wherein A is the metal, and η_{Li_depo} is between 0 mV and 8 mV, inclusive.

5. The lithium metal battery of claim 4, wherein η_{Li_depo} is between 0 mV and 5 mV, inclusive.

6. The lithium metal battery of claim 1, wherein the electrolyte is a solid electrolyte.

7. The lithium metal battery of claim 1, wherein the electrolyte is a liquid or gel electrolyte.

8. The lithium metal battery of claim 1, further comprising a cathode and a cathode current collector.

9. A lithium metal battery cell, comprising:
a cathode comprising a lithium-containing cathode active material;
an electrolyte; and
an anode comprising:
an anode current collector; and
a thin film metal layer formed on the anode current collector and consisting of a metal that satisfies formula:
η_{Li_depo}=−432.76*E_{formation} (eV)−0.3037
wherein η_{Li_depo} is lithium deposition overpotential and E_{formation} is formation energy at 1%/eV of Li99A, wherein A is the metal, and η_{Li_depo} is between 0 mV and 8 mV, inclusive.

10. The lithium metal battery cell of claim 9, wherein η_{Li_depo} is between 0 mV and 5 mV, inclusive.

11. The lithium metal battery cell of claim 9, wherein the metal forms a solid solution with lithium metal.

12. The lithium metal battery of claim 9, wherein the metal is one or more metals selected from Au, Al, Mg, Ag, Zn, and Pt.

13. The lithium metal battery of claim 9, wherein the metal is one or more metals selected from Au, Al, Mg, Ag, Zn, and Pt.

14. The lithium metal battery of claim 9, wherein the electrolyte is a solid electrolyte.

15. The lithium metal battery of claim 9, wherein the electrolyte is a liquid or gel electrolyte.
